(19) United States
(12) Patent Application Publication
(10) Pub. No.: US 2009/0244622 A1
(43) Pub. Date: Oct. 1, 2009

(54) Systems and Methods for Rendering Print Data

(76) Inventor: Markus Maresch, Boulder, CO (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/060,030

(22) Filed: Mar. 31, 2008

(51) Int. Cl. G06F 15/00; G06K 9/36

(52) U.S. Cl. 358/1.16; 382/232

(57) ABSTRACT

Systems and methods consistent with some embodiments presented provide methods for rendering print data. In some embodiments of methods for rendering print data comprising at least one compressed image object may include generating a display list by parsing the print data. The compressed image object may be identified in the display list by a reference to the at least one compressed image object. In some embodiments, the display list may be rasterized and converted to a bitmap. In some embodiments, the reference to the at least one compressed image object may be used to retrieve the at least one compressed image object. The retrieved compressed image object may be decoded and rasterized to generate a bitmap of the decoded image.

### BACKGROUND

1. Field of the Invention

The present invention relates to the field of printing and in particular, to methods for optimizing memory and processing requirements during rasterization and rendering of high resolution compressed images.

2. Description of Related Art

High resolution digital images are a common component of electronically stored documents. These images may often be defined by high colorimetric and spatial resolution. High resolution images can occupy large amounts of memory and are therefore often stored in compressed formats, such as Joint Photographic Experts Group (“JPEG”) or Portable Network Graphics (“PNG”). Even lower resolution images can occupy significant amounts of memory. In uncompressed form, the images may be described by a bitmap.

Electronic documents that include compressed images may often require decompression prior to both rasterization and integration into the display lists. The decompression process, however, may consume significant computing resources and accordingly degrade performance. Moreover, decompressed high-resolution images may often exceed the storage capacity typically allocated for a display lists. In these cases, a swap file on secondary storage or other storage media may be used to provide additional storage capacity. However, time delays in accessing swap files in secondary storage may introduce additional delays and consume other resources potentially available for rasterization thereby reducing printer performance. Thus, there is a need for methods and systems to optimize the rasterization and rendering of documents with image content for printing.

### SUMMARY

In accordance with the present invention, systems and methods for rendering print data are presented. In some embodiments, a method for rendering print data, wherein the print data comprises at least one compressed image object, the method comprising generating a display list by parsing the print data, wherein the at least one compressed image object is identified in the display list by a reference to the at least one compressed image object; and rasterizing the display list, wherein rasterization further comprises using the reference to the at least one compressed image object to retrieve the at least one compressed image object; decoding the retrieved compressed image object; and creating a bitmap using the decoded image object.

Embodiments of the present invention also relate to instructions created, stored, accessed, or modified by processors using computer-readable media and/or computer-readable memory.

These and other embodiments are further explained below with respect to the following figures.

### BRIEF DESCRIPTION OF THE DRAWINGS

FIG. 1 shows a block diagram illustrating components in a system for printing documents.

FIG. 2 shows a high level block diagram of an exemplary printer.

FIG. 3 shows an exemplary high-level data flow between modules in a system for rendering print data.

FIG. 4 shows an exemplary lower level data flow between modules in an exemplary raster information processor module for rendering print data.

FIG. 5 shows a flowchart illustrating steps in an exemplary method for rendering print data.

### DETAILED DESCRIPTION

Reference will now be made in detail to one or more exemplary embodiments of the present invention as illustrated in the accompanying drawings to refer to the same or like parts.

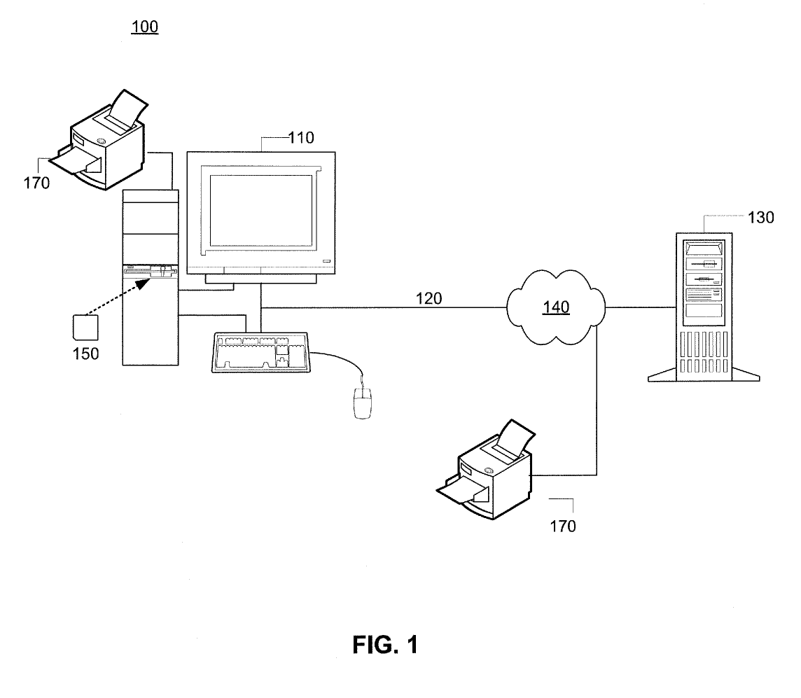

FIG. 1 shows a block diagram illustrating components in a system for printing documents according to some embodiments of the present invention. A computer software application consistent with the present invention may be deployed on a network of computers, as shown in FIG. 1, that are connected through communication links that allow information to be exchanged using conventional communication protocols and/or data port interfaces.

As shown in FIG. 1, exemplary system 100 includes computers including computing device 110 and server 130. Further, computing device 110 and server 130 may communicate over connection 120, which may pass through network 140, which in one case could be the Internet. Computing device 110 may be a computer workstation, desktop computer, laptop computer, or any other computing device capable of being used in a networked environment. Server 130 may be a platform capable of connecting to computing device 110 and other devices (not shown). Computing device 110 and server 130 may be capable of executing software (not shown) that allows the printing of documents using printers 170.

Exemplary printer 170 includes devices that produce physical documents from electronic data including, but not limited to, laser printers, ink-jet printers, LED printers, plotters, facsimile machines, and digital copiers. In some embodiments, printer 170 may also be capable of directly printing documents received from computing device 110 or server 130 over connection 120. In some embodiments, such an arrangement may allow for the direct printing of documents, with (or without) additional processing by computing device 110 or server 130. In some embodiments, documents may contain one or more of text, graphics, and images. Image data may be compressed when stored in electronic form. Accordingly, decompression may be performed on compressed image data prior to printing. In some embodiments, printer 170 may receive PDL or PPML descriptions of documents for printing. A PDL description is often translated to a series of lower-level printer-specific commands when the document is being printed. The process of translation from a PDL description of a document to a lower-level description that may be used to place marks on a print medium is termed rasterization.

Note that document print processing can be distributed. Thus, computing device 110, server 130, and/or the printer may perform portions of document print processing such as half-toning, color matching, and/or other manipulation processes before a document is physically printed by printer 170.

Computing device 110 also contains removable media drive 150. Removable media drive 150 may include, for example, 3.5 inch floppy drives, CD-ROM drives, DVD ROM drives, CD±RW or DVD±RW drives, USB flash drives, and/or any other removable media drives consistent with embodiments of the present invention. In some embodiments, portions of the software application may reside on removable media and be read and executed by computing device 110 using removable media drive 150.

Connection 120 couples computing device 110, server 130, and printer 170 and may be implemented as a wired or wireless connection using conventional communication protocols and/or data port interfaces. In general, connections 120 can be any communication channel that allows transmission of data between the devices. In one embodiment, for example, the devices may be provided with conventional data ports, such as parallel ports, serial ports, Ethernet, USB, SCSI, FIREWIRE, and/or coaxial cable ports for transmission of data through the appropriate connection. In some embodiments, connection 120 may be a Digital Subscriber Line (DSL), an Asymmetric Digital Subscriber Line (ADSL), or a cable connection. The communication links could be wireless links or wired links or any combination consistent with embodiments of the present invention that allows communication between the various devices.

Network 140 could include a Local Area Network (LAN), a Wide Area Network (WAN), or the Internet. In some embodiments, information sent over network 140 may be encrypted to ensure the security of the data being transmitted. Printer 170 may be connected to network 140 through connection 120. In some embodiments, printer 170 may also be connected directly to computing device 110 and/or server 130. System 100 may also include other peripheral devices (not shown), according to some embodiments of the present invention. A computer software application consistent with the present invention may be deployed on any of the exemplary computers, as shown in FIG. 1. For example, computing device 110 could execute software that may be downloaded directly from server 130. Portions of the application may also be executed by printer 170 in accordance with some embodiments of the present invention.

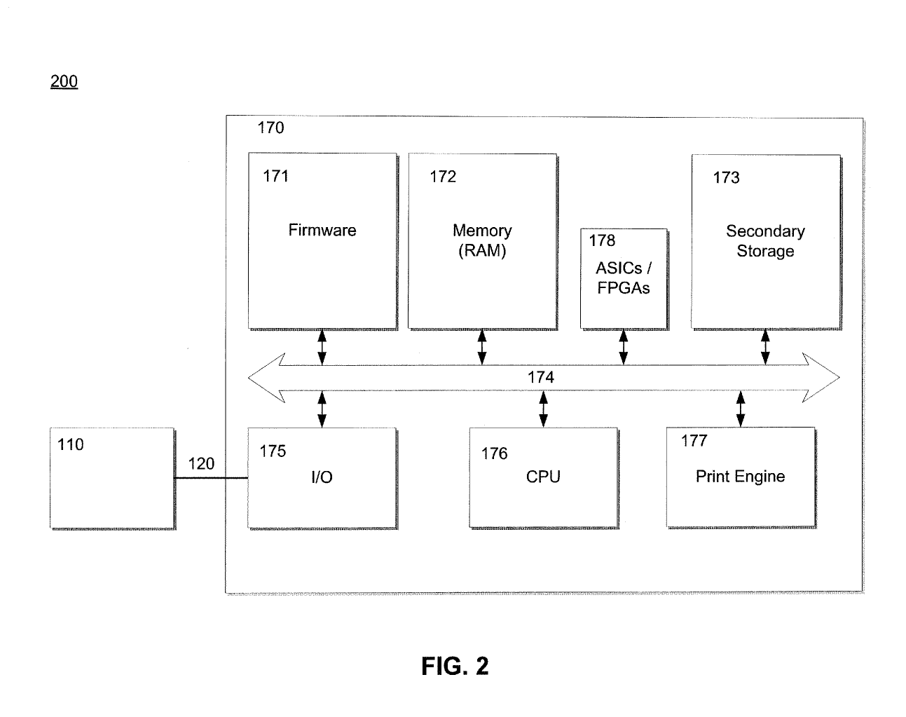

FIG. 2 shows a high-level block diagram 200 of exemplary printer 170. In some embodiments, printer 170 may contain bus 174 that couples CPU 176, firmware 171, memory 172, input-output ports 175, print engine 177, and secondary storage device 173. Exemplary secondary storage 173 may be an internal or external hard disk, memory stick, or any other memory storage device capable of being used by system 200. Printer 170 may also contain other Application Specific Integrated Circuits (ASICs), and/or Field Programmable Gate Arrays (FPGAs) 178 that are capable of executing portions of an application to print documents according to some embodiments of the present invention. In some embodiments, printer 170 may also be able to access secondary storage or other memory in computing device 110 using I/O ports 175 and connection 120. In some embodiments, printer 170 may also be capable of executing software including a printer operating system and other appropriate application software. In some embodiments, printer 170 may allow paper sizes, output trays, color selections, and print resolution, among other options, to be user-configurable.

In some embodiments, CPU 176 may be a general-purpose processor, a special purpose processor, or an embedded processor. CPU 176 can exchange data including control information and instructions with memory 172 and/or firmware 171. Memory 172 may be any type of Dynamic Random Access Memory (“DRAM”) such as but not limited to SDRAM, or RDRAM. Firmware 171 may hold instructions and data including but not limited to a boot-up sequence, pre-defined routines, and other code. In some embodiments, code and data in firmware 171 may be copied to memory 172 prior to being acted upon by CPU 176. Routines in firmware 171 may include code to translate page descriptions received from computing device 110 to display lists and image bands. In some embodiments, firmware 171 may include rasterization routines to convert display commands in a display lists to an appropriate rasterized bit map and store the bit map in memory 172. Firmware 171 may also include compression and decompression routines and memory management routines. In some embodiments, data and instructions in firmware 171 may be upgradeable.

In some embodiments, CPU 176 may act upon instructions and data and provide control and data to ASICs/FPGAs 178 and print engine 177 to generate printed documents. In some embodiments, ASICs/FPGAs 178 may also provide control and data to print engine 177. FPGAs/ASICs 178 may also implement one or more of translation, compression, decompression, and rasterization algorithms. In some embodiments, computing device 110 can transform document data into a first printable data. Then, the first printable data can be sent to printer 170 for transformation into intermediate printable data. Printer 170 may transform intermediate printable data into a final form of printable data and print according to this final form.

In some embodiments, rasterization may be performed using ASIC/FPGA 178, CPU 176, or a combination thereof. In other embodiments, rasterization may also be performed using software, firmware, hardware, or combination thereof. For example, ASIC/FPGA 178, CPU 176, or a combination thereof may be used to convert PDL formatted data into intermediate data, which may take the form of a display list, and may include a list of objects and low-level drawing commands associated with the objects. Once the display list is complete, ASIC/FPGA 178, CPU 176, or a combination thereof can rasterize the objects, transform the raw bit map, and provide a bitmap to a frame buffer or print engine to place marks on printable media. In some embodiments, the first printable data may correspond to a PDL or PPML description of a document.

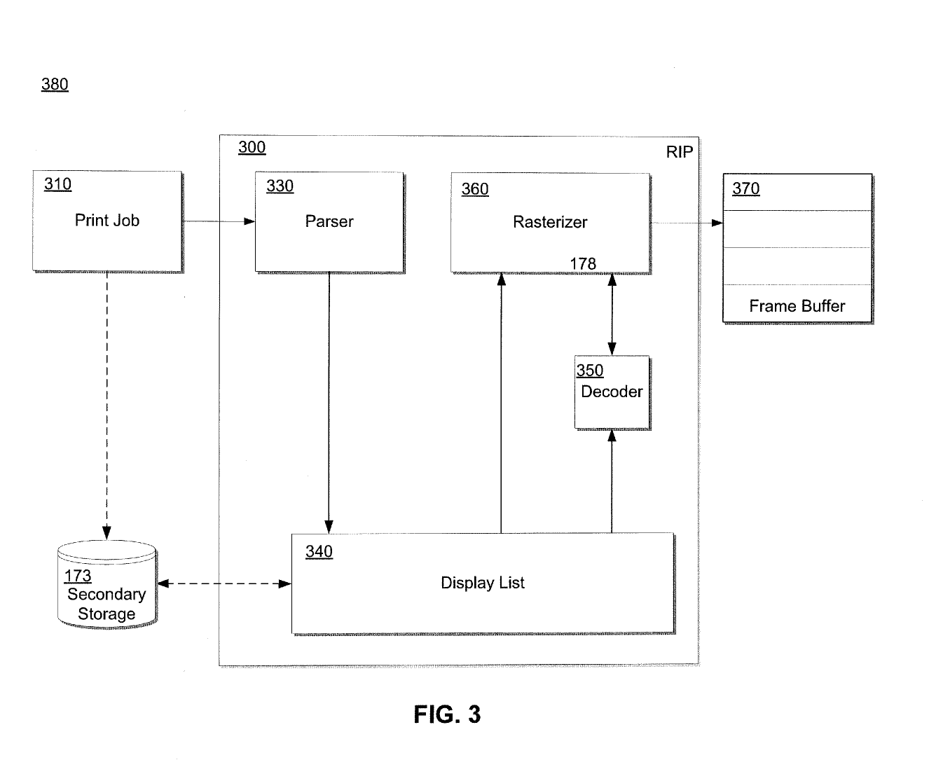

FIG. 3 shows an exemplary high-level data flow 380 between modules in a system for rendering print data. As shown in FIG. 3, the system comprises, inter alia, RIP module 300, secondary storage 173, and frame buffer 370. RIP module 300 may comprise parser 330, decoder 350, and rasterizer 360. In some embodiments, parser 330, decoder 350, and rasterizer 360 communicate with each other and may also create, modify, and perform other operations on display lists 340.

As shown in FIG. 3, parser 330 can receive print job 310 from computing device 110 and may use PDL language objects present in print job 310 to generate display lists 340. In other embodiments, display lists 340 may hold one or more of text, graphics, command, image header, and image data objects. These display commands may include data comprising characters or text, line drawings or vectors, and images or raster data. In some embodiments, objects in display lists 340 may correspond to similar objects in a user document. In some embodiments, display lists 340 may be stored in memory 172 or secondary storage 173. In some embodiments, the display lists may reside in one or more of printer 170, computing device 110, and server 130. Memory to store display lists may be a dedicated memory or form part of general purpose memory, or some combination thereof according to disclosed embodiments. Display lists 340 may be a second or intermediate step in the processing of data prior to actual printing and may be parsed before conversion into a subsequent form. In some embodiments the subsequent form may be a final representation.

In some embodiments, RIP module 300 may be implemented as a software application, or in firmware 171 using CPU 176; or using ASIC/FPGA 178, or by some combination thereof. RIP module 300 can receive and operate on data in print job 310 to facilitate the generation of frame buffer 370. In some embodiments, print job 310 may comprise a sequence of drawing commands and language objects. The sequence may include drawing commands associated with text objects, graphics objects, and/or image objects. In some embodiments, the images corresponding to image objects in print job 310 may comprise high-resolution images. High resolution images may be defined by high calorimetric and spatial resolution.

In some embodiments, the images corresponding to image objects in print job 310 may be compressed using common compression algorithms, including but not limited to JPEG, GIF, TIFF and/or PNG. In some embodiments, the images corresponding to image objects associated with print job 310 may be stored in secondary storage 173. In other embodiments, images corresponding to image objects associated with print job 310 may stored on other computer readable storage media coupled to computing device 110 or printer 170 (not shown) either alone or in combination with secondary storage 173.

In one embodiment, a reference pertaining to the image stored in secondary storage 173 may be used in display list 340 to identify and locate the image. In some embodiments, the reference may include an image header and/or other identifying and location information. In some embodiments, the reference may point to the location of the image object in memory, or in secondary storage. For example, the reference may include a pointer to a read function providing access to the image. The pointer may provide address and other information associated with the image object.

in some embodiments, processing print job 310 by parser 330 may comprise placing drawing commands associated with text and graphics directly into display list 340 based on a PDL definition associated with print job 310. In cases where print job 310 contains images, parser 330 can place an image header or some other descriptive reference corresponding to the image object in display list 340. In some embodiments, images in the print job may continue to remain in compressed form in memory or in secondary storage.

In some embodiments, decoder 350 can use image header or other image identification information in display list 340 to decompress retrieved compressed images. For example, decoder 350 can request the retrieval of compressed images from secondary storage 173 using information present in the reference to image objects in display list 340. In some embodiments, decoder 350 can then decompresses the compressed image.

In some embodiments, the reconstruction of the uncompressed image may proceed scan line by scan line in order from top to bottom. A scan line may be described as a 1×N array of pixels, where N may represent a first integer value. In some situations, a scan line may additionally be described as 1 to M planes deep. Here, M may represent a second integer value. For example, when image data consists of information in M multiple color planes, the scan line may include 1 line of data comprising of N pixels for each of the M color planes. Decoder 350 may receive a pointer to a read function to access an image from secondary storage 173. In some embodiments, the read function may be system specific. Decoder 350 may also output scan lines for reconstructing the decompressed image. In some embodiments, decoder 350 may be implemented in one of hardware, software, or some combination thereof. For example, decoder 350 may be implemented in firmware 171, CPU 176, ASIC/FPGA 178, or some combination thereof.

In some embodiments, rasterizer 360 can read data and drawing commands from display lists 340 and decompressed scan lines from decoder 350. and store its output in frame buffer 370. In some embodiments, frame buffer 370 may be part of memory 172. In some embodiments, data in frame buffer 370 may be organized as discrete horizontal bands to optimize processing. Frame buffer 370 may hold a rectangular bitmap specifying the marks to be made on a printed page for print job 310. Print engine 177, may process the rasterized data in frame buffer 370, and form a printable image of the page on a print medium, such as paper. In some embodiments, routines for rasterizer 360 may be provided in firmware 171 or may be implemented using ASICs/FPGAs 178.

FIG. 3 shows some functional blocks in an exemplary system for rendering print data, the modules and/or functional blocks shown can be implemented variously using hardware, software, or some combination of hardware and software. For example, CPU 176 could copy parser 330 from firmware 171 to memory 172 and execute parsing operations on the data in print job 310. Decoding and decompression operations may be implemented using ASIC and/or FPGAs 178 and operate under the control of an operating system for printer 170 running on CPU 176.

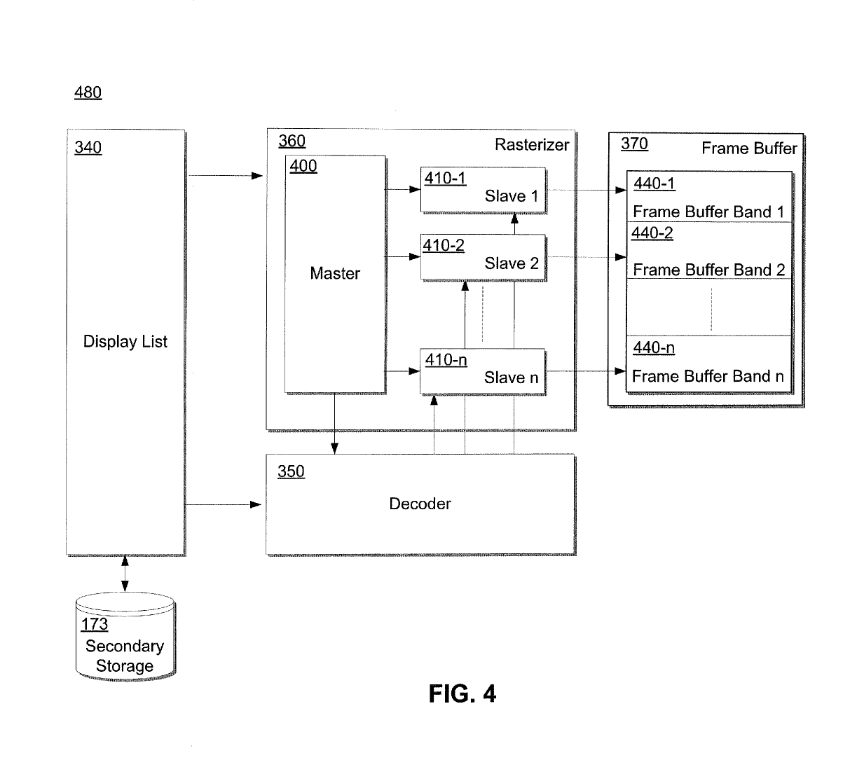

FIG. 4 shows a lower level data flow 480 between modules in exemplary raster information processor module 300 for rendering print data. In some embodiments, rasterizer 360 may include, among other things, master rasterizer 400 and slave rasterizers 410, including one or more slave rasterizers 410-1-410-n, where n is the integral number of slave rasterizers. Master rasterizer 400 may receive drawing commands from display lists 340 to arbitrate and control execution of drawing command sequences among some combination of slave rasterizers 410-1, 410-2, through 410-n. In some embodiments, master rasterizer 400 may also be coupled to decoder 350 to direct decompressed scan lines from decoder 350 to a particular slave rasterizer for rendering.

In some embodiments, slave rasterizers 410-1, 410-2, through 410-n may execute drawing commands associated with a particular region of frame buffer 370. As shown in FIG. 4, memory frame buffer 370 may be segmented into a plurality of distinct contiguous bands 440 to receive the output of rasterizer 360. For example, frame buffer band 1 440-1 may be coupled to receive the output of slave rasterizer 410-1. Similarly, in other embodiments, frame buffer band 2 440-2 through frame buffer band n 440-n may also be coupled to receive the output of slave rasterizer 2 410-2 through slave rasterizer n 410-n, respectively. In some embodiments, slave rasterizer 1 410-1 is coupled to receive a scan line output from decoder 350. The output of decoder 350 may point to a scan line buffer in the process space of slave rasterizer 1 410-1 based on master rasterizer 400. Similarly, in other embodiments, the output of decoder 350 may point to scan line buffers in the process space of slave rasterizer 2 410-2 through slave rasterizer n 410-n.

In some embodiments, decoder 350 and rasterizer 360 may process compressed images and display lists 340 commands in parallel. In some embodiments, decoder 350 can decompress an image sequentially, reconstructing each image referenced by an image header in display lists 340 scan line by scan line in order from top to bottom. Decoder 350 can provide the decompressed scan lines to rasterizer 360 for processing in the same order as the original image was compressed. For example, in one embodiment, one or more slave rasterizers 4101 can rasterize the decompressed scan lines in the same logical order that was used to compress the original image. In other embodiments, parallel processing may be performed by running decoder 350 on one core of a CPU 176 with multiple cores and running rasterizers 400 and 410 on another core of CPU 176.

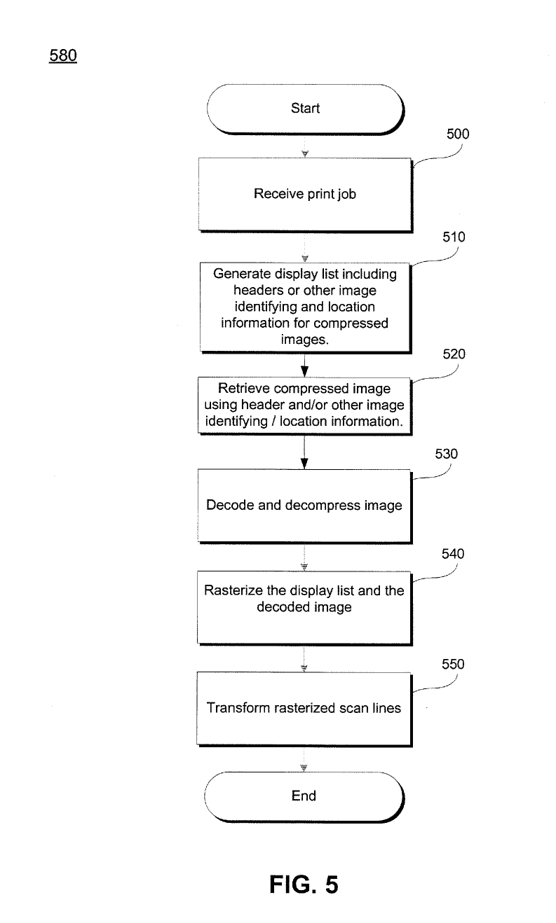

FIG. 5 shows a flowchart 580 illustrating the steps in an exemplary method for rendering print data. It will be readily appreciated by one having ordinary skill in the art that the illustrated procedure can be altered to combine, delete and/or move steps, or further include additional steps to perform the desired operations. In step 500, print job 310 is received from computing device 110. In some embodiments, data in print job 310 may be received by parser 330. Moreover, print job 310 may comprise a sequence of language objects and drawing commands. The sequence of drawing commands, which may include drawing commands associated with text, graphics, or images, may be passed to parser 330. In some embodiments, the images contained in print job 310 may be compressed.

In step 510, display list 340 is generated based on print job 310. In some embodiments, parser 330 may generate display list 340. For example, parser 330 may provide drawing commands associated with text and graphics directly into display lists 340 based on a PDL definition associated with print job 310. In some embodiments, print job 310 may also include a pointer or image header corresponding to a compressed image stored on secondary storage 173. In these cases, parser 330 may store the image header in the display lists 340 instead of the fully decompressed images themselves.

In step 520, a compressed image is retrieved using an image header and/or other image identifying or location information. In some embodiments, the image header may include a pointer to a read function providing access to secondary storage 173. In step 530, a compressed image identified and located by the image header in display lists 340 can be decoded. In some embodiments, decoder 350 may generate an uncompressed image as sequential decompressed scan lines, ordered from the top of the image to the bottom of the image. In some embodiments, steps 530 and 540 may be performed in parallel.

In step 540, objects in display lists 340, including image objects identified by references in display lists 340, may be rasterized. For example, rasterization of display lists 340 and each associated compressed image may be performed by rasterizer 360. For example, rasterizer 360 may generate a frame buffer by reading drawing commands from display lists 340 and rendering decompressed scan lines of each image associated with each image header.

In some embodiments, the rasterization process may be divided among a plurality of slave rasterizers, each slave rasterizer generating a particular region of the frame buffer. For example, drawing commands received by rasterizer 360 may be processed by slave rasterizers 410-1 though 410-n. Accordingly, drawing commands and decompressed scan lines associated with a particular band of frame buffer 370 may be assigned for processing to one of a plurality of slave rasterizers 410 by master rasterizer 400. For example, slave rasterizer 1 410-1, slave rasterizer 2 410-2, through slave rasterizer n 410-n may operate on frame buffer band 1 440-1, frame buffer band 2 440-2, through frame buffer band n 440-n, respectively. In some embodiments, master rasterizer 400 may arbitrate the execution of drawing commands in display lists 340 across multiple slave rasterizers coupled to a particular region of the frame buffer. In addition, master rasterizer 400 may signal to decoder 350 to direct its output to a scan line buffer in the process space associated with a particular slave rasterizer.

In step 550, rasterized scan lines may be transformed to adjust a scan line prior to output to frame buffer 370. For example, slave rasterizer 1 410-1, slave rasterizer 2 410-2, through slave rasterizer n 410-n may each transform their rasterized outputs prior to transport to frame buffer 370. In some embodiments, geometrical transformation may comprise, shifting, scaling, or other operations applied to pixels of a scan line. For example, slave rasterizer 410-1 may generate a scan line comprised of 1×N pixels. In some embodiments, slave rasterizer 410-1 may shift the scan line, scale the scan line, or perform a combination thereof to properly position the scan line for placement into frame buffer 370. Shifting may comprise an operation applied to all pixels of the scan line to place the drawing object in the correct location within frame buffer 270. In scaling an operation is applied to all pixels to resize an object and/or change the aspect ratio of the object.

Other embodiments of the present invention will be apparent to those skilled in the art from consideration of the specification and practice of one or more embodiments of the invention disclosed herein. It is intended that the specification and examples be considered as exemplary only, with a true scope and spirit of the invention being indicated by the following claims.

What is claimed is:

1. A method for rendering print data, wherein the print data comprises at least one compressed image object, the method comprising:
generating a display list by parsing the print data, wherein the at least one compressed image object is identified in the display list by a reference to the at least one compressed image object; and
rasterizing the display list, wherein rasterization further comprises:
using the reference to the at least one compressed image object to retrieve the at least one compressed image object;
decoding the retrieved compressed image object; and
creating a bitmap using the decoded image object.

2. The method of claim 1, wherein the print data comprises PDL data.

3. The method of claim 1, wherein the display list further includes text objects, graphics objects, and a plurality of drawing commands.

4. The method of claim 1, wherein decoding the retrieved compressed image object comprises:
decompressing the at least one compressed image object;
generating a plurality of decompressed scan lines representing the decoded image object; and
transforming the plurality of decompressed scan lines.

5. The method of claim 4, wherein transforming further comprises one or more of the steps of:
shifting the plurality of decompressed scan lines; and
scaling the plurality of decompressed scan lines.

6. The method of claim 1, wherein the reference is an image header that includes identification and address information for the at least one compressed image object.

7. The method of claim 1, wherein the at least one compressed image object is stored in secondary storage.

8. The method of claim 1, wherein the bitmap is stored in the frame buffer, the frame buffer further comprising a plurality of distinct contiguous segments.

9. The method of claim 8, wherein the distinct contiguous segments are rasterized in parallel.

10. A computer-readable medium that contains instructions, which when executed by a processor perform steps in a method for processing print data, wherein the print data comprises at least one compressed image object, the method comprising:
generating a display lists by parsing the print data, wherein the at least one compressed image object is identified in the display lists by a reference to the at least one compressed image object; and
rasterizing the display lists, wherein rasterization further comprises:
using the reference to the at least one compressed image object to retrieve the at least one compressed image object;
decoding the retrieved compressed image object; and
creating a bitmap using the decoded image object.

11. The computer-readable medium of claim 10, wherein decoding the retrieved compressed image object comprises:
decompressing the at least one compressed image object, wherein decompressing further comprises generating a plurality of decompressed scan lines representing the decoded image object; and
transforming the plurality of decompressed scan lines.

12. The computer-readable medium of claim 11, wherein transforming further comprises one or more of the steps of:
shifting the plurality of decompressed scan lines; and
scaling the plurality of decompressed scan lines.

13. The computer-readable medium of claim 10, wherein the reference is a header comprising address information for the at least one compressed image object.

14. The computer-readable medium of claim 10, wherein the bitmap is stored in the frame buffer, the frame buffer further comprising a plurality of distinct contiguous segments.

15. The computer-readable medium of claim 14, wherein the distinct contiguous segments are rasterized in parallel.

16. A system for rendering compressed images comprising:
an input interface configured to receive a print job, wherein the print job comprises at least one compressed image object;
a storage device configured to store the at least one compressed image object and a plurality of drawing commands for creating a display list;
a processor coupled to the input interface and the storage device, wherein the processor is configured to execute the instructions to perform the steps of:
generating the display list by parsing the print data, wherein the at least one compressed image object is identified in the display list by a reference to the at least one compressed image object; and
rasterizing the display list, wherein rasterization further comprises:
using the reference to the at least one compressed image object to retrieve the at least one compressed image object;
decoding the retrieved compressed image object; and
creating a bitmap using the decoded image object.

17. The system of claim 16, wherein decoding the retrieved compressed image object comprises:
decompressing the at least one compressed image object, wherein decompressing further comprises generating a plurality of decompressed scan lines representing the decoded image object; and
transforming the plurality of decompressed scan lines.

18. The system of claim 17, wherein transforming further comprises one or more of the steps of:
shifting the plurality of decompressed scan lines; and
scaling the plurality of decompressed scan lines.

19. The system of claim 16, wherein the reference is a header comprising address information for the at least one compressed image object.

20. The system of claim 16, wherein the bitmap is stored in the frame buffer, the frame buffer further comprising a plurality of segments.

21. The system of claim 20, wherein the distinct contiguous segments are rasterized in parallel.
